(19) United States
(12) Patent Application Publication
(10) Pub. No.: US 2002/0141089 A1
(43) Pub. Date: Oct. 3, 2002

(54) Timing recovery loop latency reduction via loop filter pre-calculation

(76) Inventors: Younggyun Kim, Irvine, CA (US); Bhavesh G. Bhakta, Plano, TX (US); David R. Gruetter, Fullerton, CA (US)

Correspondence Address: TEXAS INSTRUMENTS INCORPORATED, P O BOX 655474, M/S 3999, DALLAS, TX, 75265

(21) Appl. No.: 09/991,602

(22) Filed: Nov. 21, 2001

Related U.S. Application Data
(60) Provisional application No. 60/252,958, filed on Nov. 24, 2000.

(51) Int. Cl. G11B 5/02; G11B 19/02; G11B 21/02

(52) U.S. Cl. 360/27; 360/55; 360/75; 360/71

(57) ABSTRACT

A circuit for use in a phase locked loop includes pre-computation blocks for phase error detector and loop filter functions, a selection block (or multiplexer) of these pre-computed results based on detected (or reference signal) signal, and on ambiguity zone detector deriving the pre-computation blocks.

### FIELD OF THE INVENTION

The present invention relates to a phase locked loop detector utilizing a partial-response maximum-likelihood (PRML) system and an associated magnetic storage system using the same phase error detector.

### BACKGROUND OF THE INVENTION

Partial response, maximum likelihood (PRML) system has been known as a readout signal processing system suitable to increase recording density of a magnetic storage device, particularly using a magnetic disk drive. In the PRML system, a readout signal from a magnetic storage device is amplified and, after it has passed through a low-pass filter, is A/D converted with a clock signal synchronized with the readout signal to obtain a digital waveform sequence. A readout data sequence is obtained by equalizing the digital waveform data sequence and detecting a maximum likelihood sequence thereof. In this system, in order to synchronize the readout signal and the clock signal, a phase control circuit is used. The phase control circuit produces a clock signal by detecting a phase error between the readout signal and a sampling clock signal and controls the clock signal such that the phase error becomes zero by using a PLL control.

A phase error detection system for detecting a phase error between a readout signal and a sampling clock uses a technique in which a sampled value yₙ of an equalized waveform and xₙ resulting from ternary symbol-by-symbol decision of the sampled value are used to derive an equation:

PhaseError=−yₙxₙ₋₁+yₙ₋₁xₙ (1)

In receivers, whether communication or storage systems, the output signal of the receive filter is sampled prior to performing symbol-by-symbol or symbol sequence detection. A timing-recovery scheme adjusts the sample-timing phase to minimize undesired intersymbol interference. Many applications require fast initial phase adjustment from a special synchronization preamble sent prior to user data.

However, the latency of the timing recovery loop directly affects its tracking capability to timing phase variation. The shorter the latency is, the easier to track the variation. The physical implementation of a phase error detector (PED), loop filter (LF) and voltage controlled oscillator (VCO), which are part of the timing loop, require some latency, especially for high-speed applications. This latency is required to allow time for a correct decision to be made. The latency should be reduced to the lowest value possible.

FIG. 1 illustrates a phase error detection circuit (PED), a low-pass filter (LF), and a voltage controlled oscillator (VCO) of a second-order timing recovery loop for magnetic recording channels. Here, α and β are two LF parameters referred to as proportional and integral gains, respectively.

### SUMMARY OF THE INVENTION

The present invention is used in conjunction with a pipelining technique for high-speed application and is applicable to PED, LF and VCO implementation without any latency increase. The present invention reduces overall timing recovery loop latency. Additionally, a more computationally intensive PED can be adopted without increasing latency. The present invention uses multipliers in a high-speed application and can also be pipelined without latency increase. The present invention employs ambiguity zone detection (AZD) to obtain two probable observation samples.

### BRIEF DESCRIPTION OF THE DRAWINGS

FIG. 1 illustrates a phase error detector loop filter and VCO; and

FIG. 2 illustrates a pre-calculation of the PED and LF.

FIG. 3 is a side view of a disk drive system; and

FIG. 4 is a top view of a disk drive system.

### DETAILED DESCRIPTION OF THE PRESENT INVENTION

The following invention is described with reference to figures in which similar or the same numbers represent the same or similar elements. While the invention is described in terms for achieving the invention's objectives, it can be appreciated by those skilled in the art that variations may be accomplished in view of these teachings without deviation from the spirit or scope of the invention.

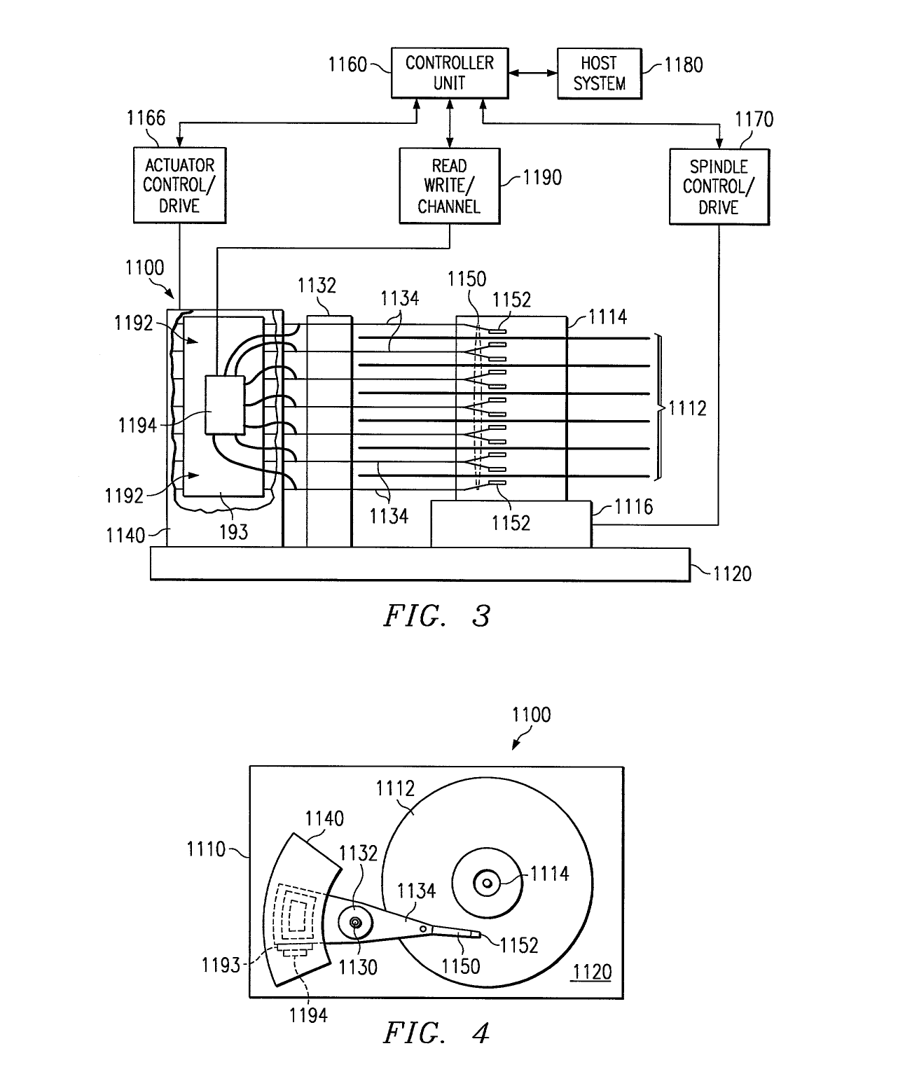

FIGS. 3 and 4 show a side and top view, respectively, of the disk drive system designated by the general reference 1100 within an enclosure 1110. The disk drive system 1100 includes a plurality of stacked magnetic recording disks 1112 mounted to a spindle 1114. The disks 1112 may be conventional particulate or thin film recording disk or, in other embodiments, they may be liquid-bearing disks. The spindle 1114 is attached to a spindle motor 1116 which rotates the spindle 1114 and disks 1112. A chassis 1120 is connected to the enclosure 1110, providing stable mechanical support for the disk drive system. The spindle motor 1116 and the actuator shaft 1130 are attached to the chassis 1120. A hub assembly 1132 rotates about the actuator shaft 1130 and supports a plurality of actuator arms 1134. The stack of actuator arms 1134 is sometimes referred to as a “comb.” A rotary voice coil motor 1140 is attached to chassis 1120 and to a rear portion of the actuator arms 1134.

A plurality of head suspension assemblies 1150 are attached to the actuator arms 1134. A plurality of inductive transducer heads 1152 are attached respectively to the suspension assemblies 1150, each head 1152 including at least one inductive write element. In addition thereto, each head 1152 may also include an inductive read element or a MR (magneto-resistive) read element. The heads 1152 are positioned proximate to the disks 1112 by the suspension assemblies 1150 so that during operation, the heads are in electromagnetic communication with the disks 1112. The rotary voice coil motor 1140 rotates the actuator arms 1134 about the actuator shaft 1130 in order to move the head suspension assemblies 1150 to the desired radial position on disks 1112.

A controller unit 1160 provides overall control to the disk drive system 1100, including rotation control of the disks 1112 and position control of the heads 1152. The controller unit 1160 typically includes (not shown) a central processing unit (CPU), a memory unit and other digital circuitry, although it should be apparent that these aspects could also be enabled as hardware logic by one skilled in the computer arts. Controller unit 1160 is connected to the actuator control/drive unit 1166 which is in turn connected to the rotary voice coil motor 1140. A host system 1180, typically a computer system or personal computer (PC), is connected to the controller unit 1160. The host system 1180 may send digital data to the controller unit 1160 to be stored on the disks, or it may request that digital data at a specified location be read from the disks 1112 and sent back to the host system 1180. A read/write channel 1190 is coupled to receive and condition read and write signals generated by the controller unit 1160 and communicate them to an arm electronics (AE) unit shown generally at 1192 through a cut-away portion of the voice coil motor 1140. The read/write channel 1190 includes the timing loop of the present invention. The AE unit 1192 includes a printed circuit board 1193, or a flexible carrier, mounted on the actuator arms 1134 or in close proximity thereto, and an AE module 1194 mounted on the printed circuit board 1193 or carrier that comprises circuitry preferably implemented in an integrated circuit (IC) chip including read drivers, write drivers, and associated control circuitry. The AE module 1194 is coupled via connections in the printed circuit board to the read/write channel 1190 and also to each read head and each write head in the plurality of heads 1152.

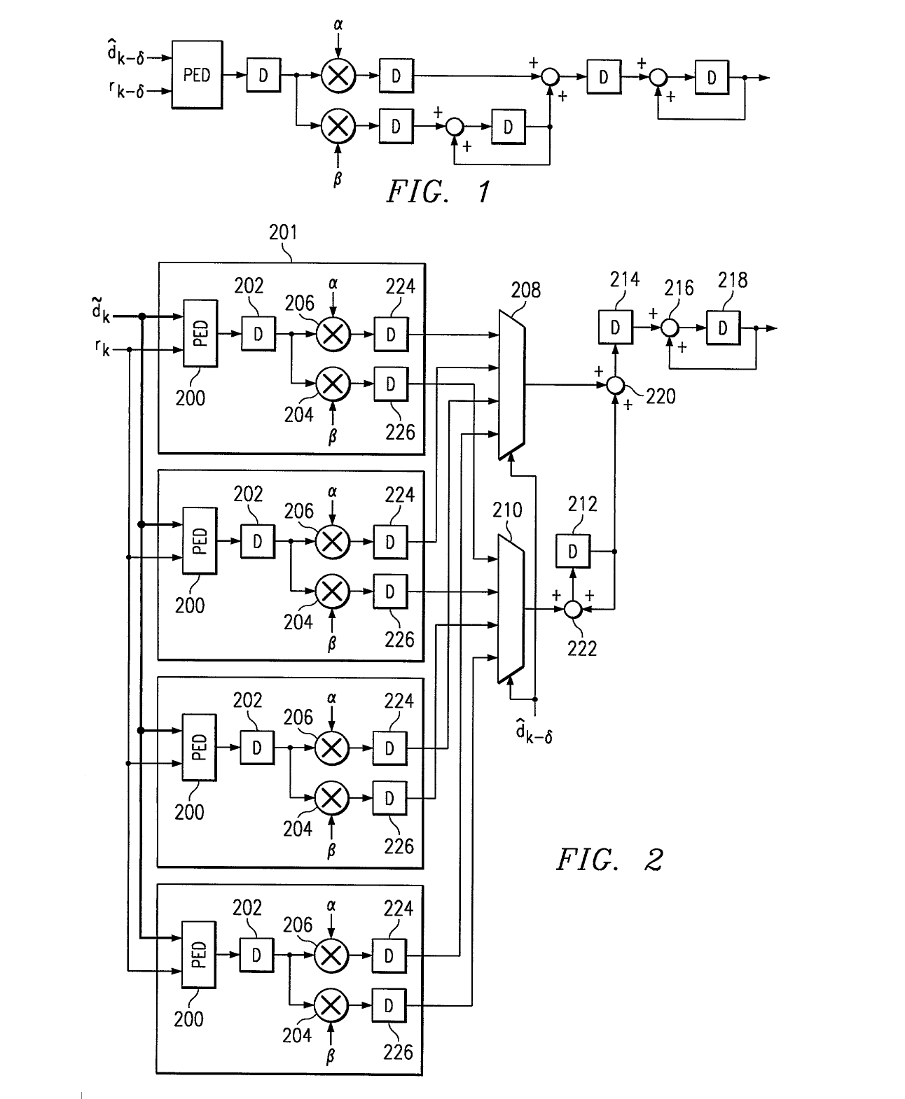

FIG. 2 illustrates a portion of an EPR4 channel of the present invention. An EPR4 channel has a response of (1, 1, −1, −1). For binary channel input symbols, noiseless channel output samples are taken from {±4, ±2, 0}, letting rₖ and dₖ be the actual (noisy) and noiseless channel output samples, respectively. FIG. 2 illustrates the PED and LF of a second-order timing recovery loop for magnetic recording channels where α and β are two LF parameters referred to as proportional and integral gains, respectively. For the PED, the partial response, maximum likelihood (PRML) scheme is considered, which is given by

\hat{τ}ₖ=\hat{d}ₖrₖ₋₁−\hat{d}ₖ₋₁rₖ (13)

where \hat{τ}ₖ is the estimate of the timing phase error and \hat{d}ₖ is the estimate of the noiseless channel output sample dₖ. The variable \hat{d}ₖ is an output of a detector which has a finite decision delay δ. To calculate \hat{τ}ₖ, two estimates are needed, \hat{d}ₖ and \hat{d}ₖ₋₁. For an EPR4 channel, which is only used for illustration (other channels could be used such as EEPR4, PR4, the two estimates, \hat{d}ₖ and \hat{d}ₖ₋₁, can typically have 25 different values. Realizing that each estimate can have five possible values, the computations and permutations result in 25 values. However, the present invention eliminates the need to calculate all of these 25 values by using an ambiguity zone detection (AZD).

The received data to the ambiguity zone detector is first divided into different ambiguity zones (AZD). Every readback sample falls into one of these regions. However, only a few values of the readback samples are then allowed as the legitimate output of the PR channel. Thus, the remaining readback values are prevented from being output by the PR channel. For example, for n=2, a maximum of only two values (instead of 5 in VA) are considered as the probable output of the PR channel. Such a restriction is justified based on the assumption that for a system with reasonably good signal-to-noise ratio, the probability that a received sampled output falls into an erroneous region of the ambiguity zones where the actual value of the channel output is none of the allowed values is correspondingly small. There is, however, a non-zero probability that yₖ will fall into an erroneous zone where the actual value of xₖ is not one of the allowed values. This is correspondingly referred to as an error in the AZ assignment.

The partial decisions about the channel output quickly eliminate some of the branches of the trellis of the PR channel since only a few branches yield permissible outputs. The AZ assignments, therefore, would translate into a list of permissible future states (PFS). The PFS corresponds to states at which survived paths could arrive.

For a noisy sample rₖ, the AZD releases two probable observation samples \tilde{d}ₖ according to the following rule:

$${\tilde{d}}_{k} = \{ \begin{matrix}( 2 , 4 ) & for {r}_{k} > 2 \\ ( 0 , 2 ) & for 0 < {r}_{k} \leq 2 \\ ( - 2 , 0 ) & for - 2 < {r}_{k} \leq 0 \\ ( - 4 , - 2 ) & otherwise\end{matrix} \qquad ( 14 )$$

The probability of dₖ∉\tilde{d}ₖ is so low that the number of pre-calculations can be reduced to 4 (each estimate having only 2 probable values). The PED of the each pre-calculation block

$$( {}_{}^{1}{d}{}_{k}^{} , {\tilde{d}}_{k - 1} ) {\tilde{d}}_{k} = \{ \begin{matrix}( 2 , 4 ) & for {r}_{k} > 2 \\ ( 0 , 2 ) & for 0 < {r}_{k} \leq 2 \\ ( - 2 , 0 ) & for - 2 < {r}_{k} \leq 0 \\ ( - 4 , - 2 ) & otherwise\end{matrix}$$

The pre-calculation technique is shown in FIG. 2, in which multipliers of low-pass filter LF are also included in the pre-calculation. The structure of FIG. 2 saves one clock cycle plus the latency required for PED compared to that of FIG. 1. By using this technique, a more computationally intensive PED can be adopted without a latency increase.

As illustrated in FIG. 2, the phase error detection circuit 200 of a pre-computation block 201 is connected to delay circuit 202. The output of the delay circuit 202 is connected to both inputs of multiplier 204 and multiplier 206. The constants of α and β are proportional and integral gain values. The output of multiplier 206 is connected to the input of delay circuit 224. The output of multiplier circuit 204 is input to delay circuit 226. The output of delay circuit 224 is input to multiplexer circuit 208. The output of delay circuit 226 is input to multiplexer circuit 210. The output of multiplexer circuit 208 is input to summing circuit 220. The output of multiplexer circuit 210 is input to summing circuit 222. [The output of multiplexer 208 is connected to summing circuit 220.] [The output of multiplexer 210 is connected to summing circuit 222.] The output of summing circuit 222 is connected to delay circuit 212. The output of delay circuit 212 is connected both to summing circuit 220 and summing circuit 222. The output of summing circuit 222 is connected to delay circuit 214. The output of delay circuit 214 is connected to summing circuit 216, which has an output connected to delay circuit 218. The output of delay circuit 218 is connected to summing circuit 216.

In operation, the input signals \tilde{d}ₖ and rₖ are input to phase error detection circuit 200. Phase error detection detects an error in phase and outputs a phase error signal to delay circuit 202. The delayed signal from delay circuit 202 is input to multipliers 206 and 204 where, in multiplier circuit 206, the output of the delay circuit 202 is multiplied by α. The output from the multiplier 206, a first multiplied signal, is input to the delay circuit 224. Likewise, the multiplier 204 multiplies the input signal from the output of delay circuit 202 by β and outputs a second multiplied signal to delay circuit 226. The output signal from each of the delay circuits 224 and 226, first delay signal and second delay signal, respectively, are input to multipliers 208 and 210, respectively. Here, the inputs of multiplexers 208 and 210 are selected by \hat{d}_{k-δ}. The output of the multiplexers which correspond to the equation is input to summing circuit 220 and summing circuit 222. The output of summing circuit 222, second summed signal, is input to delay circuit 212, and the output of delay circuit 212 is summed by summing circuit 222 to output a first summed signal. Additionally, the output of delay circuit 212 is input to summing circuit 220 where the output of multiplexer circuit 208 and the output of delay circuit 212 are summed together in summing circuit 220. The output of summing circuit 220 is input to delay circuit 214 where the input signal is delayed. The output of delay circuit 214 is summed by summing circuit 216. The output of delay circuit 218 is input to summing circuit 216.

FIG. 2 illustrates four similar low-pass filters.

1. A circuit for use in a phase lock loop, including:
a first phase error detector to detect and generate the first phase error between input signals;
a second phase error detector to detect and generate a second phase error between a different set of input signals; and
a multiplex circuit to select the first phase error signal and the second phase error signal.

2. A circuit for use in a phase lock loop, including:
pre-computation blocks including phase error detector and loop filter to output a detected circuit;
a selection block to select the first phase error and the second phase error signal of the pre-computed result based on detected signal; and
an ambiguity tone detector reducing the complexity of the pre-computation circuits, by reducing the numbers of pre-computation blocks.
